(19) United States
(12) Patent Application Publication
(10) Pub. No.: US 2025/0355319 A1
(43) Pub. Date: Nov. 20, 2025

(54) OPTICAL MEMBER DRIVING MECHANISM

(71) Applicant: TDK CORPORATION, Tokyo (JP)

(72) Inventors: Chuan-Min LEE, Taoyuan City (TW); Shu-Shan Chen, Taoyuan City (TW); Pai-Jui Cheng, Taoyuan City (TW)

(73) Assignee: TDK CORPORATION, Tokyo (JP)

(21) Appl. No.: 19/207,842

(22) Filed: May 14, 2025

Related U.S. Application Data
(60) Provisional application No. 63/648,834, filed on May 17, 2024.

(51) Int. Cl. G03B 5/00; G02B 7/04; G03B 30/00

(52) U.S. Cl. CPC G03B 5/00; G02B 7/04; G03B 30/00; G03B 2205/0069

(57) ABSTRACT

An optical member driving mechanism is provided, including a movable portion, a fixed portion, and a driving assembly. The movable portion is configured to connect an optical member, and the movable portion is movable relative to the fixed portion. The driving assembly is configured to drive the movable portion to move.

### CROSS REFERENCE TO RELATED APPLICATIONS

This application claims the benefit of U.S. Provisional Application No. 63/648,834, filed May 17, 2024, the entirety of which is incorporated by reference herein.

### BACKGROUND OF THE INVENTION

### Field of the Invention

The application relates in general to an optical member driving mechanism, and in particular it relates to an optical member driving mechanism for driving the optical member to move.

### Description of the Related Art

As technology has advanced, a lot of electronic devices (for example, cameras and smartphones) have incorporated the functionality of taking photographs and recording video. These electronic devices have become more commonplace, and have been developed to be more convenient and thin. More and more options are provided for users to choose from.

### BRIEF SUMMARY OF INVENTION

An embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

In some embodiments, the optical member driving mechanism further includes a transferring assembly and a guiding assembly. The transferring assembly is configured to transfer a driving force generated by the driving assembly to the movable portion, and includes a contacting member. The contacting member includes a first contacting part, and the first contacting part has a plate structure corresponding to the driving assembly. The guiding assembly is configured to guide a movement direction of the movable portion relative to the fixed portion, and includes a first guiding member. The first guiding member has a longitudinal structure and is extended along a longitudinal direction. As observed along the longitudinal direction, the included angle formed by a connecting line between the center of the first guiding member and the center of the first contacting part and the direction of the thickness of the first contacting part is less than 10 degrees.

In some embodiments, as observed along a main axis, the fixed portion has a polygonal structure, and the first side of the fixed portion is neither parallel nor perpendicular to the direction of the thickness of the first contacting part.

In some embodiments, as observed along the main axis, the second side of the fixed portion is neither parallel nor perpendicular to the direction of the thickness of the first contacting part, and the first side is not parallel to the second side.

In some embodiments, the driving assembly includes a driving source, a transferring member, and an amplifying member. The driving source is configured to generate the driving force. The transferring member is configured to transfer the driving force. The amplifying member is configured to amplify the driving force, and has a surface facing the driving source. As observed along a direction that is perpendicular to the surface, the amplifying member has a polygonal structure, and the extending direction of the first edge of the amplifying member is neither parallel nor perpendicular to the direction of the thickness of the first contacting part.

In some embodiments, as observed along a direction that is perpendicular to the surface, the extending direction of the second edge of the amplifying member is neither parallel nor perpendicular to the direction of the thickness of the first contacting part, and the extending direction of the first edge is not parallel to the extending direction of the second edge.

In some embodiments, the fixed portion includes a lower housing and an upper housing, the lower housing includes a bottom wall, the upper housing includes a supporting pillar, and the supporting pillar is extended toward the bottom wall and in contact with the bottom wall, wherein the movable portion includes an arc-shaped trimming surface facing the supporting pillar.

In some embodiments, the upper housing further includes an L-shaped wall, and the L-shaped wall is extended toward the bottom wall and in contact with the bottom wall, wherein the fixed portion has a polygonal structure, and the supporting pillar and the L-shaped wall are disposed on different corners of the fixed portion.

In some embodiments, the L-shaped wall has at least one glue recess formed thereon.

In some embodiments, the optical member driving mechanism further includes a circuit assembly, the circuit assembly includes a circuit board and an electronic member, the circuit board is disposed on the L-shaped wall, and the electronic member is disposed on the circuit board.

In some embodiments, the L-shaped wall has at least one recess formed thereon, and the electronic member is accommodated in the recess.

In some embodiments, the recess penetrates the L-shaped wall.

In some embodiments, the circuit assembly further includes a first lead and a second lead. The first lead is connected to the circuit board and the driving assembly, and has a first connecting section that is in contact with the circuit board. The second lead is connected to the circuit board and the driving assembly, and has a second connecting section that is in contact with the circuit board. The first connecting section is not parallel to the second connecting section.

In some embodiments, the upper housing includes a first slot, a second slot, and a partition, the first lead is accommodated in the first slot, the second lead is accommodated in the second slot, and the partition is disposed between the first slot and the second slot.

In some embodiments, the guiding assembly includes a second guiding member that is parallel to the first guiding member and adjacent to the driving assembly.

In some embodiments, the fixed portion includes a recess, the movable portion includes a protruding part, the protruding part protrudes from the top surface of the movable portion and surrounds the second guiding member, and the protruding part is accommodated in the recess.

In some embodiments, the protruding part has a first trimming plane and a second trimming plane. The first trimming plane faces the main axis of the optical member driving mechanism, and the second trimming plane faces away from the main axis. The first trimming plane is neither parallel nor perpendicular to the second trimming plane, and the length of the first trimming plane is different from the length of the second trimming plane.

In some embodiments, the protruding part has a depression part connected to the first trimming plane.

In some embodiments, the movable portion includes an accommodating recess adjacent to the first guiding member, and an inlet of the accommodating recess faces away from the first guiding member, wherein the optical member driving mechanism further includes a magnetic member, and the magnetic member enters the accommodating recess via the inlet.

In some embodiments, the movable portion further includes an opening, formed on the bottom surface of the movable portion and communicated with the accommodating recess, wherein the width of the opening is less than the width of the accommodating recess.

### BRIEF DESCRIPTION OF DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram of an optical member driving mechanism disposed on an electronic device according to an embodiment of the invention;

FIG. 2 is a schematic diagram of the optical member driving mechanism according to an embodiment of the invention;

FIG. 3 is an exploded-view diagram of the optical member driving mechanism according to an embodiment of the invention;

FIG. 4 is a schematic diagram of an upper housing according to an embodiment of the invention;

FIG. 5 is a cross-sectional view taken along the line A-A in FIG. 2;

FIG. 6 is a schematic diagram of a transferring assembly according to an embodiment of the invention;

FIG. 7 is a cross-sectional view taken along the line B-B in FIG. 2;

FIG. 8 is a cross-sectional view taken along the line C-C in FIG. 2;

FIG. 9A is a schematic diagram of a movable portion according to an embodiment of the invention;

FIG. 9B is a bottom view of the movable portion according to an embodiment of the invention;

FIG. 9C is a schematic diagram of the movable portion in another view according to an embodiment of the invention; and

FIG. 10 is a partial enlarged diagram of the optical member driving mechanism according to an embodiment of the invention.

### DETAILED DESCRIPTION OF INVENTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

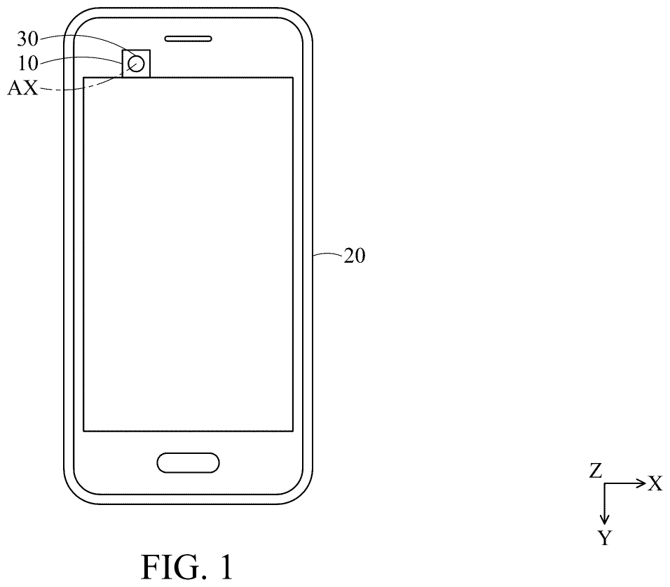

Referring to FIG. 1, an optical member driving mechanism 10 according to an embodiment of the invention can be disposed in an electronic device 20. The optical member driving mechanism 10 can be configured to hold and drive an optical member 30, so that the optical member 30 can move along a main axis AX of the optical member driving mechanism 10 relative to an image sensor (not shown) in the electronic device 20, and the purpose of focusing, zooming, and/or optical image stabilization (OIS) can be achieved. For example, the electronic device 20 can be a smartphone, a tablet computer, or a digital camera, and the optical member 30 can be a camera lens with a plurality of lenses, but it is not limited thereto.

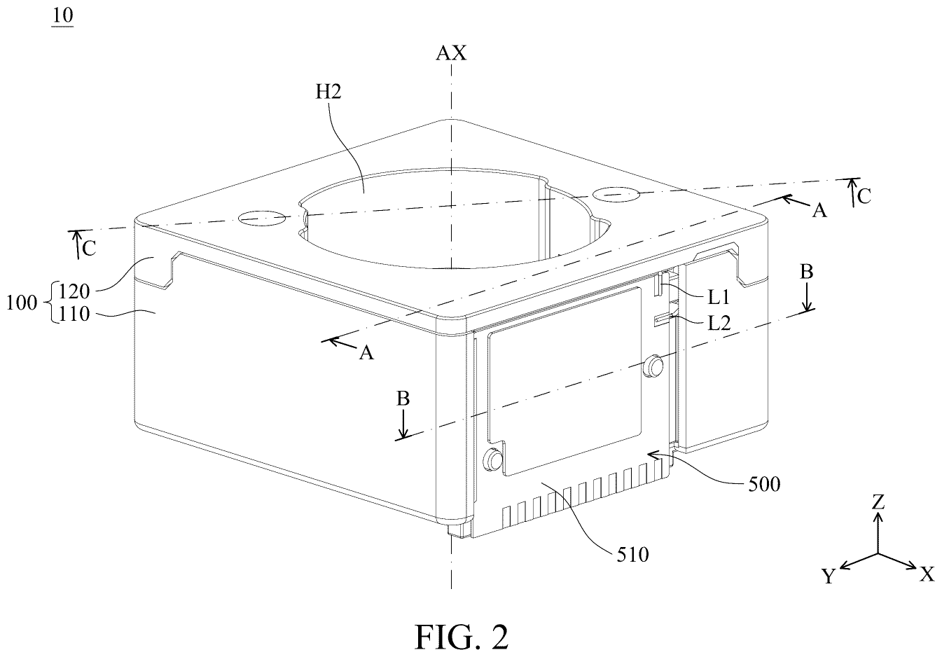

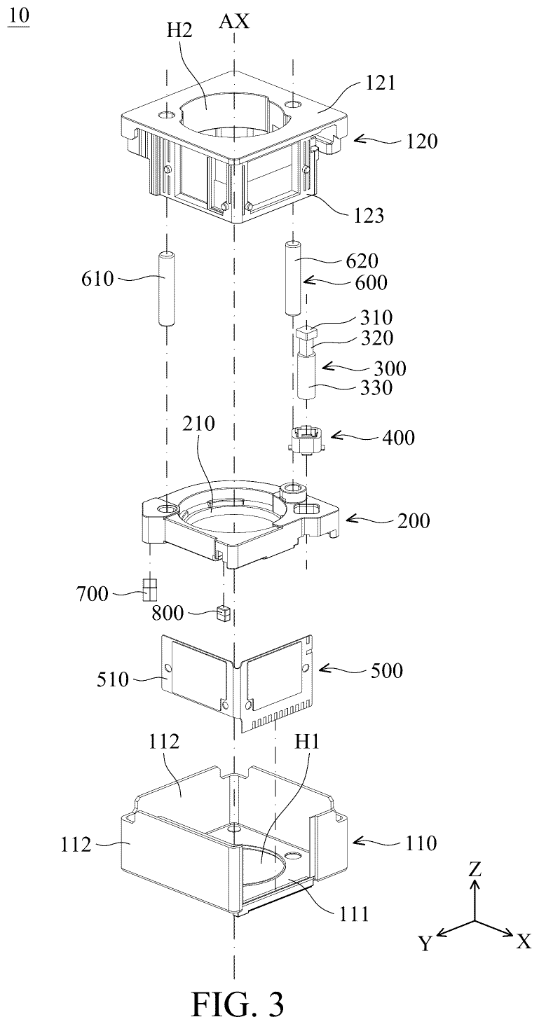

FIG. 2 is a schematic diagram of the optical member driving mechanism 10, and FIG. 3 is an exploded-view diagram of the optical member driving mechanism 10. As shown in FIG. 2 and FIG. 3, the optical member driving mechanism 10 primarily includes a fixed portion 100, a movable portion 200, a driving assembly 300, a transferring assembly 400, a circuit assembly 500, and a guiding assembly 600.

The fixed portion 100 includes a lower housing 110 and an upper housing 120, and they can be engaged with each other. As observed along the main axis AX of the optical member driving mechanism 10, the engaged fixed portion 100 can include a polygonal structure, such as a rectangle, but it is not limiter thereto. The lower housing 110 includes a bottom wall 111 and a plurality of lateral walls 112. The bottom wall 111 has an optical hole H1 formed thereon. The lateral walls 112 are connected to the peripheral edge of the bottom wall 111 and extended toward the upper housing 120.

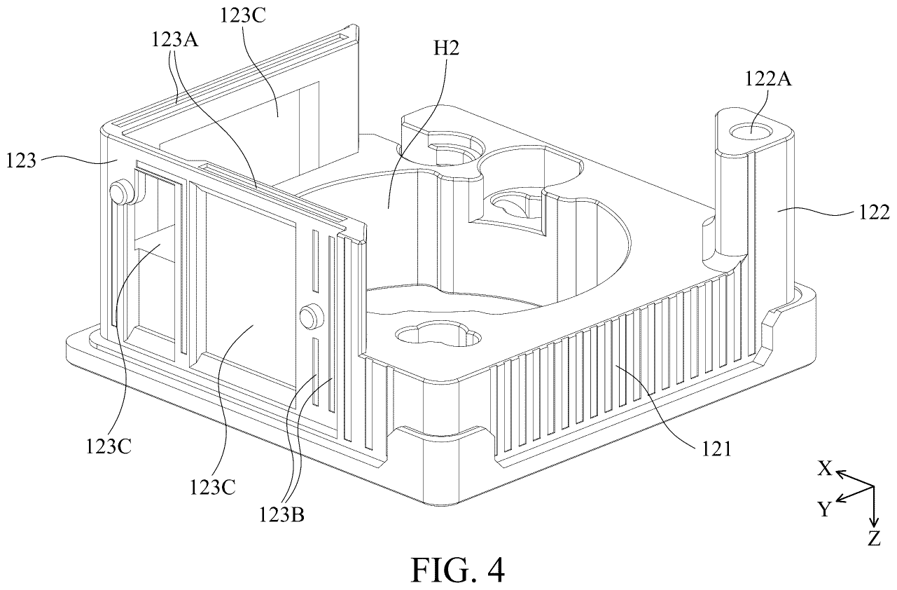

As shown in FIG. 2 to FIG. 4, the upper housing 120 includes a cover 121, a supporting pillar 122, and an L-shaped wall 123. The cover 120 has an optical hole H2 formed thereon, and the position of the optical hole H2 corresponds to the optical hole H1 on the bottom wall 111. The supporting pillar 122 and the L-shaped wall 123 are connected to the cover 120 and extended toward the bottom wall 111 of the lower housing 110, and the supporting pillar 122 and the L-shaped wall 123 are disposed on the opposite corners of the fixed portion 100. When the lower housing 110 and the upper housing 120 are engaged, the surfaces of the supporting pillar 122 and the L-shaped wall 123 facing the bottom wall 111 can be in contact with the bottom wall 111 and affixed to the bottom wall 111 via the adhesive glue. In this embodiment, the surfaces of the supporting pillar 122 and the L-shaped wall 123 facing the bottom wall 111 respectively has a glue recess 122A and a glue recess 123A formed thereon, so as to facilitate the assembly of the fixed portion 100, and the excess adhesive glue can be prevented from overflowing.

The surface of the L-shaped wall 123 facing away from the movable portion 200 can have one or more glue recesses 123B and one or more recesses 123C formed thereon. In this embodiment, some recesses 123C can penetrate the L-shaped wall 123, so that the movable portion 200 can be exposed from these recesses 123C.

The movable portion 200 has a connecting hole 210 for connecting the optical member 30, and the position of the connecting hole 210 corresponds to the positions of the optical hole H1 and the optical hole H2. Therefore, when the external light enters the optical member driving mechanism 10, it can pass through the optical hole H2, the optical member 30, and the optical hole H1 in sequence.

The driving assembly 300 is connected to the fixed portion 100, and the driving assembly 300 can be connected to the movable portion via the transferring assembly 400. Therefore, the driving force generated by the driving assembly 300 can be transferred to the movable portion 200 via the transferring assembly 400, and the movable portion 200 can move relative to the fixed portion 100.

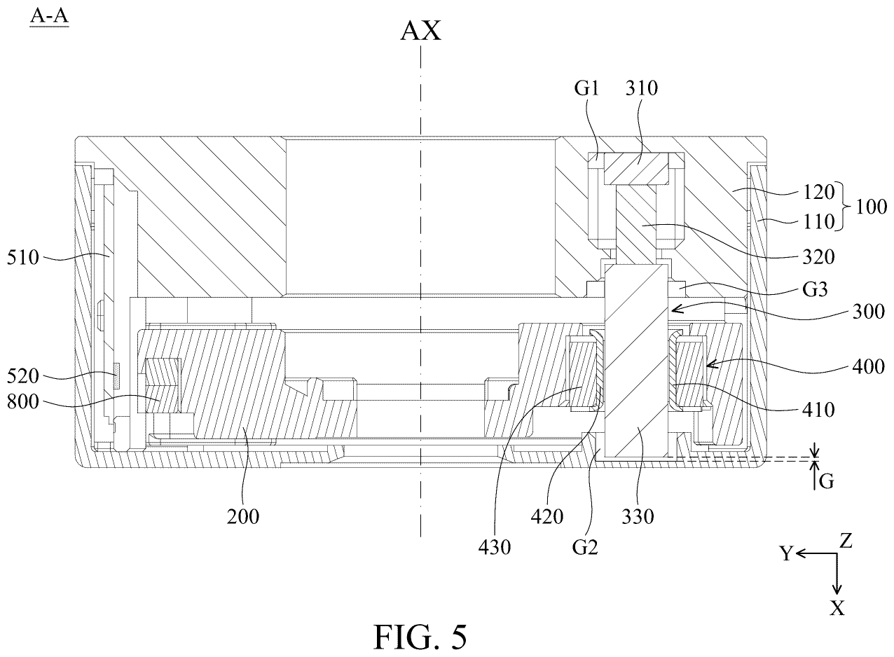

Referring to FIG. 3 and FIG. 5, in particular, the driving assembly 300 includes an amplifying member 310, a driving source 320, and a transferring member 330. The amplifying member 310, the driving source 320, and the transferring member 330 are arranged along a direction that is parallel to the main axis AX. The amplifying member 310 is affixed to the cover 121 of the upper housing 120 via a soft glue G1, the driving source 320 is connected to the amplifying member 310, the transferring member 330 is connected to the driving source 320, and the driving source 320 is disposed between the amplifying member 310 and the transferring member 330.

The driving source 320 includes a piezoelectric member. When the current flows through the driving source 320, the length of the driving source 320 in a direction that is parallel to the main axis AX is changed, and a driving force can be provided to the transferring member 330. The amplifying member 310 can be configured to amplify the driving force provided by the driving source 320. Specifically, the relative density of the amplifying member 310 can be greater than that of the fixed portion 100, and can be greater than that of the transferring member 330. For example, the relative density of the amplifying member 310 can be more than five times of the relative density of the fixed portion 100. In this embodiment, the amplifying member includes metal, and the transferring member 330 includes carbon fibers.

For ensuring that the driving assembly 300 can have sufficient space to deform, a gap G can be formed between the transferring member 330 and the lower housing 110 in a direction that is parallel to the main axis AX. For example, the gap G can be greater than 0.15 millimeters. In this embodiment, a soft glue G2 can be filled into the gap G, so as to stable the driving assembly 300 when it operates. Furthermore, a soft glue G3 that is connected to the transferring member 330 and the upper housing 120 can be disposed at the end of the transferring member 330 connected to the driving source 320, so as to stable the driving assembly 300 when it operates. It should be noted that, the Young's modulus of the soft glue G1, the soft glue G2, and the soft glue G3 are less than the Young's modulus of the amplifying member 310, so as to prevent the driving effect of the driving assembly 300 from affecting.

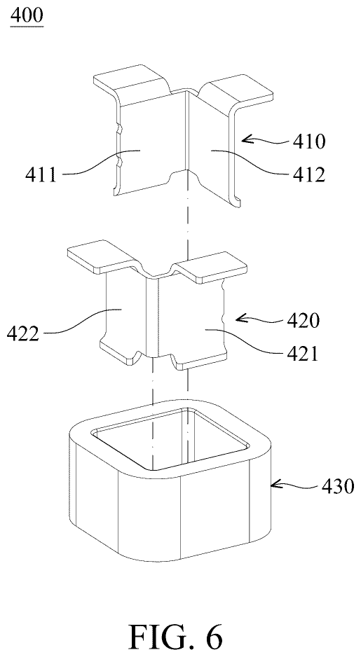

Referring to FIG. 3 to FIG. 7, the transferring assembly 400 includes a contacting member 410, a contacting member 420, and a flexible member 430. The contacting member 410 includes a first contacting part 411 and a second contacting part 412, each of them has a plate structure, and the first contacting part 411 is substantially perpendicular to the second contacting part 412. Similarly, the contacting member 420 includes a third contacting part 421 and a fourth contacting part 422, each of them has a plate structure, and the third contacting part 421 is substantially perpendicular to the fourth contacting part 422. The flexible member 430 has an annular structure, and can include rubber or silicone gel, but it is not limited thereto.

When the driving assembly 300 is connected to the movable portion 200 via the transferring assembly 400, the flexible member 430 surrounds the contacting member 410 and the contacting member 420. The first contacting part 411 and the second contacting part 412 of the contacting member 410 are in contact with the inner surface of the flexible member 430 and the transferring member 330, the third contacting part 421 and the fourth contacting part 422 of the contacting member 420 are in contact with the inner surface of the flexible member 430 and the transferring member 330, and the outer surface of the flexible member 430 is in contact with the movable portion 200. Therefore, when the driving assembly 300 is not working, it can be ensured that the transferring assembly 400 is clamped on the transferring member 330, and the movable portion 200 that is connected to the transferring assembly 400 can be positioned at a desired position. The contacting member 410 and the contacting member 420 can include metal, therefore, when the driving assembly 300 is working, the contacting member 410 and the contacting member 420 can reduce the friction between the transferring assembly 400 and the transferring member 330.

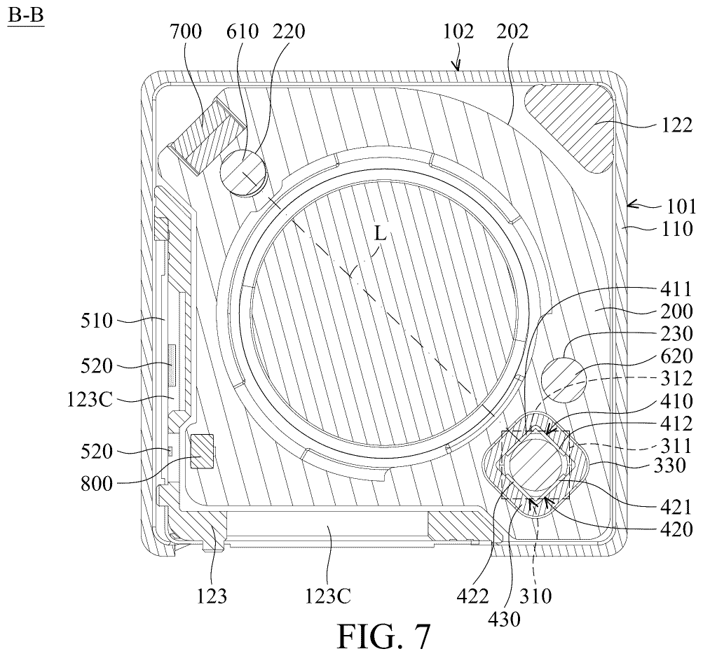

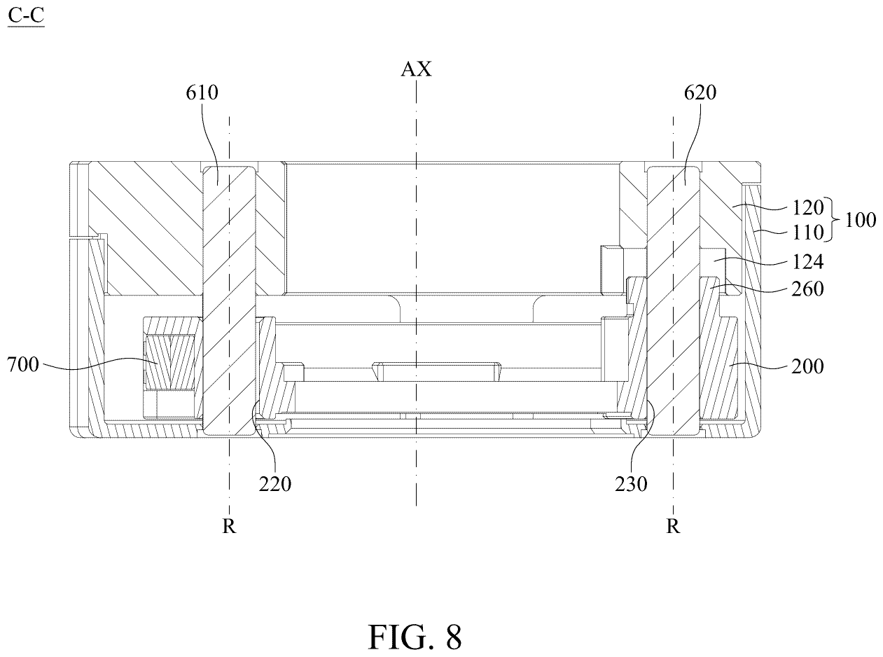

Referring to FIG. 7 and FIG. 8, the guiding assembly 600 includes a first guiding member 610 and a second guiding member 620, and each of them has a longitudinal structure extending along a longitudinal direction R. The longitudinal direction R is substantially parallel to the main axis AX of the optical member driving mechanism 10. The first guiding member 610 is affixed to the fixed portion 100 and passes through the hole 220 on the movable portion 200. Thus, when the driving assembly 300 drives the movable portion 200 to move relative to the fixed portion 100, the movable portion 200 can move along the extending direction of the first guiding member 610.

The second guiding member 620 is affixed to the fixed portion 100 and adjacent to the driving assembly 300, and passes through the hole 230 on the movable portion 200. Thus, when the driving assembly 300 drives the movable portion 200 to move relative to the fixed portion 100, the movable portion 200 can move along the extending direction of the second guiding member 620. It should be noted that, the cross-sectional dimensions of the hole 220 passing by the first guiding member 610 is slightly greater than the cross-sectional dimensions of the first guiding member 610, and the cross-sectional dimensions of the hole 230 passing by the second guiding member 620 is substantially the same as the cross-sectional dimensions of the second guiding member 620, so that the assembly of the optical member driving mechanism 10 can be facilitated.

A magnetic member 700 can be disposed on the movable portion 200, and can be adjacent to the first guiding member 610. Therefore, owing to the magnetic attraction force between the magnetic member 700 and the first guiding member 610, it can be ensured that the movable portion 200 is attached on the first guising member 610 during the movement.

In this embodiment, an included angle formed by a connecting line L between the center of the first contacting part 411 of the contacting member 410 and the center of the first guiding member 610 and the direction of the thickness of the first contacting part 411 can be less than 10 degrees (for example, it can be 0 degrees, in other words, the first contacting part 411 is perpendicular to the connecting line L), the magnetic member 700 can be disposed on the extending direction of the connecting line L, and the first guiding member 610 can be disposed between the magnetic member 700 and the driving assembly 300. Therefore, the reliability of the optical member driving mechanism 10 in the operation can be further enhanced.

Moreover, as observed along the main axis AX, the fixed portion 100 has a polygonal structure (such as a rectangle). Since the first guiding member 610 and the driving assembly 300 are respectively disposed on the opposite corners of the fixed portion 100, the first side 101 of the fixed portion 100 is neither parallel nor perpendicular to the direction of the thickness of the first contacting part 411, and the second side 102 of the fixed portion 100 that is perpendicular to the first side 101 is likewise neither parallel nor perpendicular to the direction of the thickness of the first contacting part 411.

Similarly, in this embodiment, the amplifying member 310 has a polygonal structure (such as a rectangle). As observed along a direction that is perpendicular to the surface of the amplifying member 310 facing the driving source 320, the first edge 311 of the amplifying member 310 is neither parallel nor perpendicular to the direction of the thickness of the first contacting part 411, and the second edge 312 of the amplifying member 310 that is perpendicular to the first edge 311 is likewise neither parallel nor perpendicular to the direction of the thickness of the first contacting part 411.

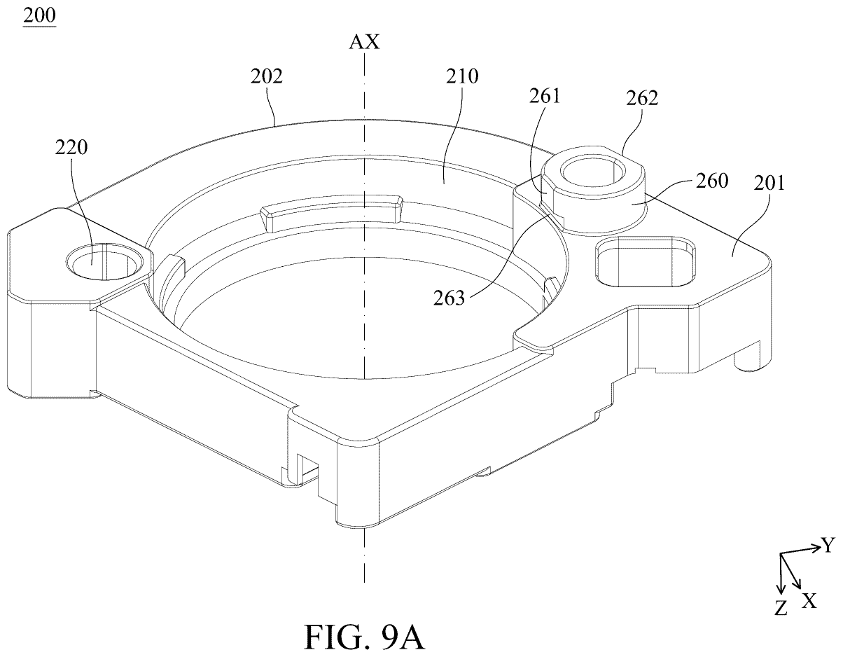

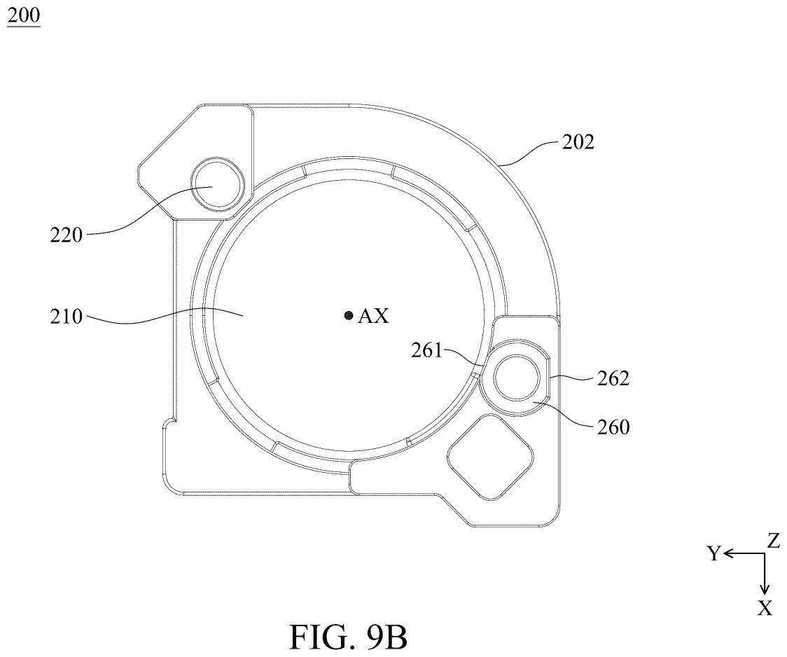

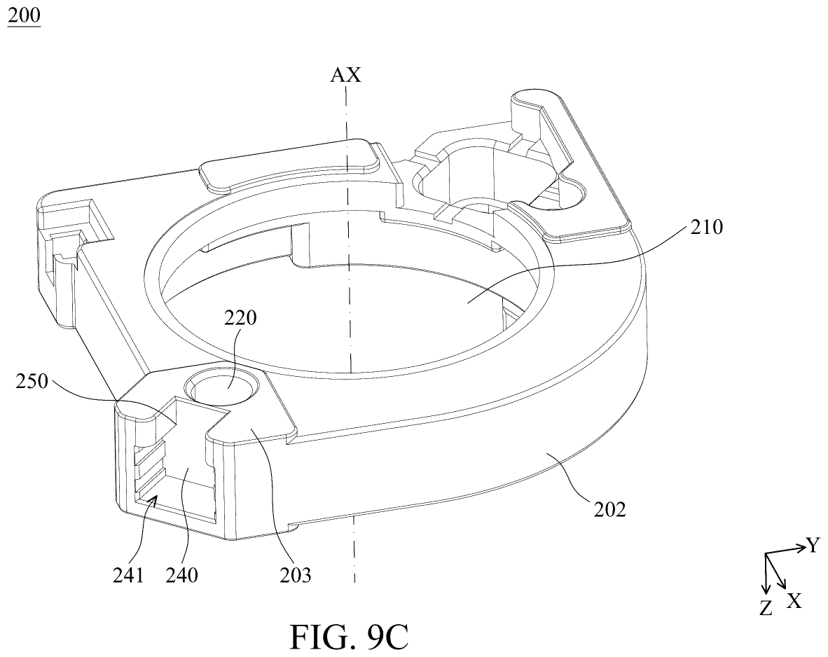

Referring to FIG. 7 to FIG. 9C, the magnetic member 700 can be accommodated in an accommodating recess 240 of the movable portion 200. The inlet 241 of the accommodating recess 240 is formed on the side surface of the movable portion 200, so that the inlet 241 faces away from the first guiding member 610. Thus, the magnetic member 700 can enter the accommodating recess 240 via the inlet 241, and the assembly of the magnetic member 700 is facilitated. In this embodiment, the movable portion 200 further includes an opening 250 that is formed on the bottom surface 203 of the movable portion 200 and communicated with the accommodating recess 240. The opening 250 can facilitate the user to check whether the magnetic member 700 is positioned. The width of the opening 250 is less than the width of the accommodating recess 240, so that the magnetic member 700 does not fall from the opening 250.

The movable portion 200 further includes a protruding part 260, and the protruding part 260 protrudes from the top surface 201 of the movable portion 200 and surrounds the second guiding member 620. The upper housing 120 includes a recess 124 corresponding to the protruding part 260, and at least a portion of the protruding part 260 is accommodated in the recess 124. Specifically, the protruding part 260 has a first trimming plane 261 facing the main axis AX, a second trimming plane 262 facing away from the main axis AX, and a depression part 263 connected to the first trimming plane 261. The lengths of the first trimming plane 261 and the second trimming plane 262 are different, and they are neither parallel nor perpendicular to each other. Owing to the first trimming plane 261, the second trimming plane 262, and the depression part 263, the scattered light of the optical member driving mechanism 10 can be reduced, and the optical quality of the optical member driving mechanism 10 can be increased.

The movable portion 200 further includes an arc-shaped trimming surface 202. The arc-shaped trimming surface 202 faces the supporting pillar 122 of the fixed portion 100 and is spaced away from the supporting pillar 122. Therefore, the lightweight and the miniaturization of the optical member driving mechanism 10 can be facilitated.

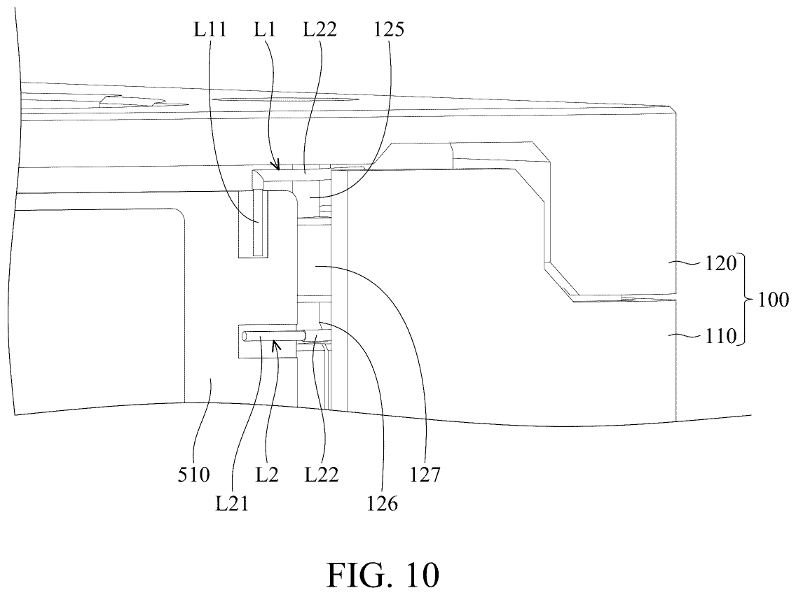

Referring to FIG. 2 to FIG. 5 and FIG. 10, the circuit assembly 500 includes a circuit board 510 and a plurality of electronic members 520. The circuit board 510 is disposed on the L-shaped wall 123 of the upper housing 120, and the electronic members 520 are disposed on the circuit board 510. In particular, the adhesive glue can be filled into the glue recess 123B on the L-shaped wall 123, and then the circuit board 510 can be laterally connected to the L-shaped wall 123. Therefore, the circuit board 510 can be adhered to the L-shaped wall 123. When the circuit board 510 is assembled on the L-shaped wall 123, the electronic members 520 can be accommodated in the recesses 123C, so as to facilitate the miniaturization of the optical member driving mechanism 10.

The electronic members 520 can include a sensor. This electronic member 520, which behavior as the sensor, can correspond to a sensing object 800 disposed on the movable portion 200 to detect the position of the movable portion relative to the fixed portion 100. For example, the electronic member 520 which behavior as the sensor can be a Hall sensor, a magnetoresistance effect sensor (MR sensor), a giant magnetoresistance effect sensor (GMR sensor), a tunneling magnetoresistance effect sensor (TMR sensor), or a fluxgate sensor, and the sensing object 800 can be a magnet, but it is not limited thereto.

The circuit board 510 can be connected to the driving source 320 of the driving assembly 300 by a first lead L1 and a second lead L2. The first lead L1 has a first connecting section L11 that is in contact with the circuit board 510, and the second lead L2 has a second connecting section L21 that is in contact with the circuit board 510. The first connecting section L11 is not parallel to the second connecting section L21, so as to prevent the interference therebetween due to the parasitic current.

The upper housing 120 of the fixed portion 100 includes a first slot 125, a second slot 126, and a partition 127. The section L12 of the first lead L1 can be accommodated in the first slot 125, the section L22 of the second lead L2 can be accommodated in the second slot 126, and the partition 127 can be disposed between the first slot 125 and the second slot 126. Therefore, even the section L12 of the first lead L1 and the section L22 of the second lead L2 are parallel, they are partitioned by the partition 127, so that the interference between the first lead L1 and the second lead L2 due to the parasitic current can be prevented.

In summary, an embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move.

2. The optical member driving mechanism as claimed in claim 1, wherein the optical member driving mechanism further comprises:
a transferring assembly, configured to transfer a driving force generated by the driving assembly to the movable portion, and comprising a contacting member, wherein the contacting member comprises a first contacting part, and the first contacting part has a plate structure corresponding to the driving assembly; and
a guiding assembly, configured to guide a movement direction of the movable portion relative to the fixed portion, and comprising a first guiding member, wherein the first guiding member has a longitudinal structure and is extended along a longitudinal direction,
wherein as observed along the longitudinal direction, an included angle formed by a connecting line between the center of the first guiding member and the center of the first contacting part and a direction of a thickness of the first contacting part is less than 10 degrees.

3. The optical member driving mechanism as claimed in claim 2, wherein as observed along a main axis, the fixed portion has a polygonal structure, and a first side of the fixed portion is neither parallel nor perpendicular to the direction of the thickness of the first contacting part.

4. The optical member driving mechanism as claimed in claim 3, wherein as observed along the main axis, a second side of the fixed portion is neither parallel nor perpendicular to the direction of the thickness of the first contacting part, and the first side is not parallel to the second side.

5. The optical member driving mechanism as claimed in claim 2, wherein the driving assembly comprises:
a driving source, configured to generate the driving force;
a transferring member, configured to transfer the driving force; and
an amplifying member, configured to amplify the driving force, and having a surface facing the driving source, wherein as observed along a direction that is perpendicular to the surface, the amplifying member has a polygonal structure, and an extending direction of a first edge of the amplifying member is neither parallel nor perpendicular to the direction of the thickness of the first contacting part.

6. The optical member driving mechanism as claimed in claim 5, wherein as observed along the direction that is perpendicular to the surface, an extending direction of a second edge of the amplifying member is neither parallel nor perpendicular to the direction of the thickness of the first contacting part, and the extending direction of the first edge is not parallel to the extending direction of the second edge.

7. The optical member driving mechanism as claimed in claim 2, wherein the fixed portion comprises a lower housing and an upper housing, the lower housing comprises a bottom wall, the upper housing comprises a supporting pillar, and the supporting pillar is extended toward the bottom wall and in contact with the bottom wall, wherein the movable portion comprises an arc-shaped trimming surface facing the supporting pillar.

8. The optical member driving mechanism as claimed in claim 7, wherein the upper housing further comprises an L-shaped wall, and the L-shaped wall is extended toward the bottom wall and in contact with the bottom wall, wherein the fixed portion has a polygonal structure, and the supporting pillar and the L-shaped wall are disposed on different corners of the fixed portion.

9. The optical member driving mechanism as claimed in claim 8, wherein the L-shaped wall has at least one glue recess formed thereon.

10. The optical member driving mechanism as claimed in claim 8, wherein the optical member driving mechanism further comprises a circuit assembly, the circuit assembly comprises a circuit board and an electronic member, the circuit board is disposed on the L-shaped wall, and the electronic member is disposed on the circuit board.

11. The optical member driving mechanism as claimed in claim 10, wherein the L-shaped wall has at least one recess formed thereon, and the electronic member is accommodated in the recess.

12. The optical member driving mechanism as claimed in claim 11, wherein the recess penetrates the L-shaped wall.

13. The optical member driving mechanism as claimed in claim 10, wherein the circuit assembly further comprises:
a first lead, connected to the circuit board and the driving assembly, and having a first connecting section that is in contact with the circuit board; and
a second lead, connected to the circuit board and the driving assembly, and having a second connecting section that is in contact with the circuit board, wherein the first connecting section is not parallel to the second connecting section.

14. The optical member driving mechanism as claimed in claim 13, wherein the upper housing comprises a first slot, a second slot, and a partition, the first lead is accommodated in the first slot, the second lead is accommodated in the second slot, and the partition is disposed between the first slot and the second slot.

15. The optical member driving mechanism as claimed in claim 2, wherein the guiding assembly comprises a second guiding member that is parallel to the first guiding member and adjacent to the driving assembly.

16. The optical member driving mechanism as claimed in claim 15, wherein the fixed portion comprises a recess, the movable portion comprises a protruding part, the protruding part protrudes from a top surface of the movable portion and surrounds the second guiding member, and the protruding part is accommodated in the recess.

17. The optical member driving mechanism as claimed in claim 16, wherein the protruding part has a first trimming plane and a second trimming plane, the first trimming plane faces a main axis of the optical member driving mechanism, and the second trimming plane faces away from the main axis, wherein the first trimming plane is neither parallel nor perpendicular to the second trimming plane, and a length of the first trimming plane is different from a length of the second trimming plane.

18. The optical member driving mechanism as claimed in claim 17, wherein the protruding part has a depression part connected to the first trimming plane.

19. The optical member driving mechanism as claimed in claim 2, wherein the movable portion comprises an accommodating recess adjacent to the first guiding member, and an inlet of the accommodating recess faces away from the first guiding member, wherein the optical member driving mechanism further comprises a magnetic member, and the magnetic member enters the accommodating recess via the inlet.

20. The optical member driving mechanism as claimed in claim 19, wherein the movable portion further comprises an opening, formed on a bottom surface of the movable portion and communicated with the accommodating recess, wherein a width of the opening is less than a width of the accommodating recess.
